(19) United States
(12) Patent Application Publication
(10) Pub. No.: US 2019/0376455 A1
(43) Pub. Date: Dec. 12, 2019

(54) INTERNAL COMBUSTION ENGINE CONTROL

(71) Applicant: GM Global Technology Operations LLC, Detroit, MI (US)

(72) Inventors: Anthony E. Locano, Macomb Township, MI (US); Ronald E. Gaskins, Kokomo, IN (US); Charles F. Maguire III, Metamora, MI (US); Timothy J. Clever, Waterford, MI (US)

(21) Appl. No.: 16/005,028

(22) Filed: Jun. 11, 2018

(51) Int. Cl. F02D 13/02; F01L 1/344

(52) U.S. Cl. CPC F02D 13/0249; F02D 2200/0612; F02D 2200/025; F01L 1/344

(57) ABSTRACT

A method for controlling an internal combustion engine includes providing an internal combustion engine having an exhaust camshaft phaser and a knock sensor. A second step includes starting the internal combustion engine and receiving a first knock sensor signal from the knock sensor. A third step includes determining a first octane rating based on the first knock sensor signal and an algorithm. A fourth step includes communicating a camshaft timing change to the exhaust camshaft phaser if the first octane rating is less than 100%.

### TECHNICAL FIELD

The present disclosure relates to internal combustion engines and more specifically to a method of controlling an internal combustion engine to achieve optimum performance and durability.

### INTRODUCTION

In the effort to enhance the efficiency, reliability, durability, and performance of internal combustion engines (ICE), engine design engineers and engine software calibrators have contributed greatly to the advancement of ICE. Design engineers have provided hardware having improved capability in areas such as materials, electronic based controls, and mechanical based adjustable systems. Once the hardware is provided, engine calibrators are tasked with finding the optimum operating parameters under which the engine is its most powerful, efficient, drive-able, or some combination of these and many other attributes. For example, when the ICE converted from distributor ignition systems to coil-based ignition systems, calibrators we free to adjust spark timing while ambient operating conditions are changing. Furthermore, when engineers added electronic fuel injection systems and thus removed carburetors, calibrators could not only control how much fuel is injected into a cylinder or intake manifold but when the fuel is injected.

Since engineers and calibrators have achieved the capability to control more closely the fuel and spark portions of the ICE, the next step is to more fully control the air component of ICE. This is accomplished by varying the timing of the valves that add and remove air from the combustion chamber. Calibrators have shown the capability to improve the efficiency and performance of ICEs while concurrently reducing emissions. While today's ICE engineers and calibrators accomplish many of the goals that ICE are designed for, increasing cost efficiency, fuel efficiency, and emissions standards have rendered these accomplishments less effective. Accordingly, there is a need in the art for improved ICE controls that pushes fuel efficiency and power output to another level while addressing ever constricting emission standards and maintaining durability and reliability.

### SUMMARY

The present disclosure includes a method of controlling an internal combustion engine for a vehicle. The method includes providing an internal combustion engine having an exhaust camshaft phaser and a knock sensor. A second step includes starting the internal combustion engine and receiving a first knock sensor signal from the knock sensor. A third step includes determining a first octane rating (OR) based on the first knock sensor signal and an algorithm. A fourth step includes communicating a camshaft timing change to the exhaust camshaft phaser if the first octane rating (OR) is less than 100%.

In one example of the following disclosure, the method further comprises maintaining a current camshaft timing if the first octane rating (OR) is 100%.

In another example of the following disclosure, the method further comprises receiving a second knock sensor signal from the knock sensor, determining a second octane rating (OR) based on the second knock sensor signal and the algorithm, and communicating a camshaft timing change to the exhaust camshaft phaser if the second octane rating (OR) is less than 100%.

In yet another example of the following disclosure, the method further comprises receiving a second knock sensor signal from the knock sensor, determining a second octane rating (OR) based on the second knock sensor signal and the algorithm, and maintaining a current camshaft timing if the second octane rating (OR) is 100%.

In yet another example of the following disclosure, the method further comprises communicating a camshaft timing change to the exhaust camshaft phaser if the first octane rating (OR) is less than 100%. The camshaft timing change (Pd) is calculated by the following equation:

Pd=Pf−(OR*Pf).
Pf is a full phaser shift.

In yet another example of the following disclosure, the method further comprises setting the full phaser shift as approximately −25°.

In yet another example of the following disclosure, the method further comprises setting the full phaser shift as approximately −12.5°.

In yet another example of the following disclosure, the method step of providing a vehicle having an internal combustion engine having an exhaust camshaft phaser and a knock sensor further comprises providing a vehicle having an internal combustion engine having an exhaust camshaft phaser and a flat-response knock sensor.

The above features and advantages and other features and advantages of the present disclosure are readily apparent from the following detailed description when taken in connection with the accompanying drawings.

### BRIEF DESCRIPTION OF THE DRAWING

The drawings described herein are for illustration purposes only and are not intended to limit the scope of the present disclosure in any way.

FIG. 1 is a schematic of a vehicle system having an internal combustion engine according to the principles of the present disclosure;

FIG. 2 is a sectional view of a cylinder bore, piston and cylinder head assembly according to the principles of the present disclosure;

FIG. 3 is a graph depicting valve timing by displaying valve lift vs. crankshaft position according to the principles of the present disclosure;

FIG. 4 is a flowchart depicting a method of controlling an internal combustion engine according to the principles of the present disclosure, and

FIG. 5 is a graph depicting the relationship between a calculated octane rating and camshaft phaser shift change.

### DESCRIPTION

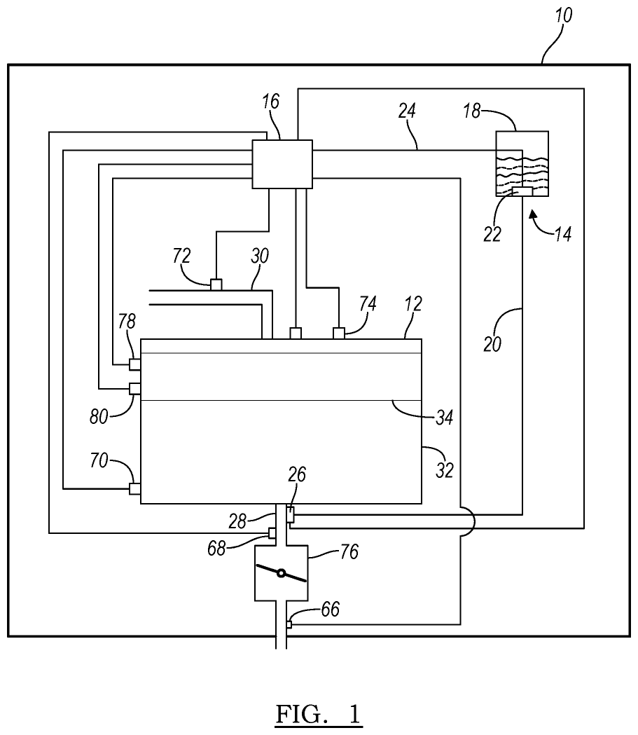

Referring to the drawings, wherein like reference numbers refer to like components, in FIG. 1 a vehicle system 10 powered by an internal combustion engine (ICE) 12 is illustrated in accordance with the present disclosure and will now be described. In addition to the ICE 12, the vehicle system 10 includes several systems that interact with the ICE 12 in one manner or another. For example, the vehicle system 10 also includes a fuel system 14 and a powertrain or engine control module (PCM or ECM) 16 which interacts with the ICE 12 and many other of the systems of the vehicle system 10. The fuel system 14 as part of the vehicle system 10 interacts with the ICE 12 through storing and providing pressurized fuel. The fuel system includes a fuel tank 18 and fuel lines 20. A fuel pump 22 is disposed in the fuel tank 18 and sends pressurized fuel to the ICE 12. The fuel pump 22 is in communication through a wire harness 24 with the PCM 16 that commands the fuel pump 22 to pressurize the fuel lines 20 with fuel when required.

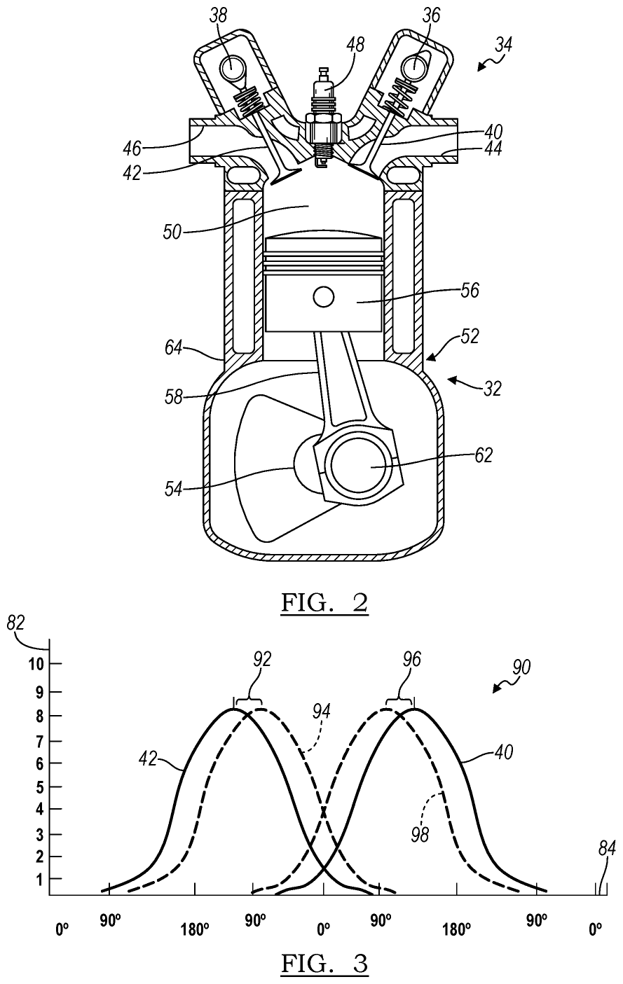

The ICE 12 includes several subsystems such as a fuel subsystem 26, an intake manifold 28, an exhaust manifold 30, a long block assembly 32, and at least one cylinder head assembly 34. The cylinder head assembly 34 and long block assembly 32 each include several components clearly shown in FIG. 2. More specifically, the cylinder head assembly 34 includes an intake camshaft 36, an exhaust camshaft 38, a plurality of intake valves 40, a plurality of exhaust valves 42, a plurality of intake ports 44, a plurality of exhaust ports 46, and a plurality of spark plugs 48. The number of valves, ports, spark plugs, and camshafts vary according to the design of the ICE 12. In particular, some ICE 12 may have anywhere from one to 16 cylinders in any I, V, W, and flat configuration although more than 16 cylinders are possible without departing from the scope of the disclosure. Cylinder head assemblies 34 have at least one intake valve 40, one exhaust valve 42, one intake port 44, one exhaust port 46, and one spark plug 48 per cylinder. Still, almost any combination of multiple valves, ports, and spark plugs are considered as a part of this disclosure. In the particular example shown in FIG. 2, the intake camshaft 36 controls the actuation of the intake valve 40 and thus the flow of an air/fuel mixture through the intake port 44 into a combustion chamber 50 formed by a combination of the cylinder head assembly 34 and the long block assembly 32. Likewise, the exhaust camshaft 38 controls the actuation of the exhaust valve 42 and thus the flow of the burnt or burning air/fuel mixture from the combustion chamber 50 through the exhaust port 46.

The long block assembly 32 of the ICE 12 includes a piston assembly 52 for each cylinder and a crankshaft 54. The piston assembly includes a piston 56 and a connecting rod 58 connected by a piston pin 60. The connecting rod 58 is rotatably connected to both the piston assembly 52 on one end and an offset journal 62 of the crankshaft 54 on the opposite end. The piston 56 reciprocates in the cylinder while the crankshaft 54 is spun by the offset connection to the piston 56. The crankshaft 54 is rotatably supported by an engine block 64 of the long block assembly 32 and is drivingly connected for common rotation with a flywheel (not shown) or torque converter (not shown) and the transmission (not shown).

The ICE 12 also includes several actuators and sensors that communicate with the PCM 16 to establish optimal operating parameters for a given set of variable inputs. For example, the ICE 12 may include a mass air flow (MAF) sensor 66, a manifold air pressure (MAP) sensor 68, a crankshaft position sensor (CPS) 70, an exhaust gas oxygen (HEGO) sensor 72, and a knock sensor 74. The MAF sensor 66 provides the PCM 16 with the amount of air is flowing into the intake manifold 28 through the throttle body 76. The MAP sensor 68 senses the air pressure within the intake manifold 28. The CPS 70 detects the rotational position of the crankshaft 54. The position of the crankshaft 54 is described in degrees of rotation. A HEGO sensor 72 detects the amount of oxygen of the exhaust gas in the exhaust manifold 30. The HEGO sensor 72 provides an indication on the efficiency of the combustion process to the PCM 16 to be used in algorithms for deciding upon a change to the air/fuel ratio being instructed to the fuel subsystem 26. The knock sensor 74 detects frequency events that are evidence of pre-ignition of the air/fuel mixture in the cylinder or knocking. In the present disclosure, the knock sensor 74 may be a flat-response style knock sensor 74. However, other types of knocks sensors may be considered without departing form the scope of the disclosure. Pre-ignition occurs when the air/fuel mixture ignites in the cylinder prior to spark plug ignition. Knocking occurs when a separate pocket of air/fuel mixture ignites outside of the normal propagation of the flame front initiated by the spark plug. The occurrence of either pre-ignition or knocking is highly damaging to the piston 56, connecting rod 58 and crankshaft 54 because of a large increase in cylinder pressure when the piston 56 is moving to decrease the volume of the cylinder as opposed to increasing the volume of the cylinder. The proper timing of ignition or propagation of the flame front is such that peak cylinder pressure is sometime after the piston 56 reaches top dead center (TDC) positon.

Of the several actuators of the ICE 12, the cylinder head assembly 34 further includes an intake cam phaser 78 and an exhaust cam phaser 80. While the intake and exhaust cams 36, 38 are rotatably driven by the crankshaft 54 via a belt or chain (not shown), the phasers 78, 80 allow for a change in the timing relationship between the camshafts 36, 38 and the crankshaft 54. In some instances, the phasers 78, 80 can retard (delay) or advance the camshafts timing 36, 38 up to 60° of crankshaft 54 rotation. The phasers 78, 80 are in electronic communication with the PCM and controlled based on information from above mentioned sensors of the ICE 12 as well as other data received from other sensors in the vehicle or preprogramed data tables.

Turning now to FIG. 3, a graph 90 is displayed showing the relationship between the height (y-axis) 82 of the intake valve 40 and exhaust valve 42 opening and crankshaft 54 position (x-axis) 84. Each position of the piston 56, Top Dead Center (TDC) and Bottom Dead Center (BDC), in relation to the crankshaft 54 occurs twice in one combustion cycle. However, rotation of the camshafts 36, 38 occurs only once in the combustion cycle. Therefore, the valves 40, 42 open and close only one time each per cylinder during one full combustion cycle or two crankshaft revolutions.

When requested by the PCM 16, each of the intake cam phaser 78 and exhaust cam phaser 80 can retard or advance the opening of the intake and exhaust valves 40, 42, respectively. For example, actuating the exhaust cam phaser 80 rotates the exhaust cam shaft 38 relative to an input or drive sprocket (not shown) of the exhaust cam phaser 80 and therefore the crankshaft 54. In the graph 90, the exhaust cam phaser 80 actuation is evidenced by the shift 92 of the retarded exhaust valve 94 opening. In a similar fashion, actuating the intake cam phaser 78 rotates the intake cam shaft 36 relative to an input or drive sprocket (not shown) of the intake cam phaser 78 and therefore the crankshaft 54. The cam phasers 78, 80 may also be used to advance the exhaust cam 38 or retard the intake cam 36 without departing from the scope of the present disclosure.

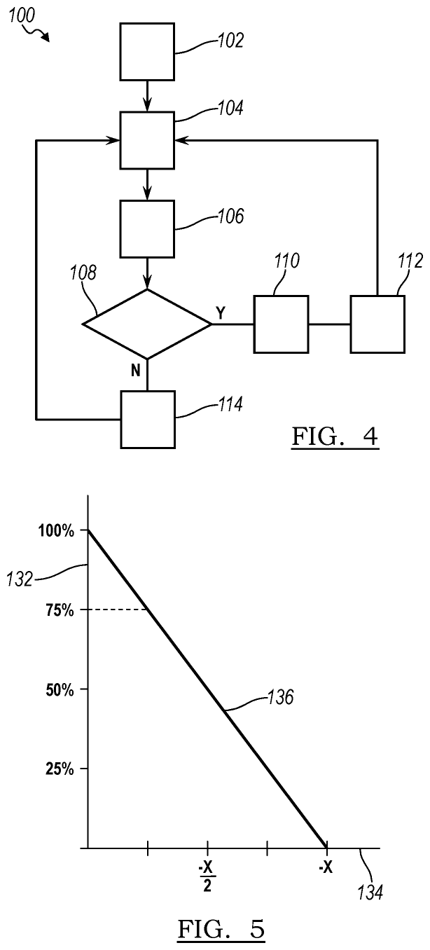

Turning now to FIGS. 4 and 5, a method 100 of controlling the ICE 12 is shown in the flowchart of FIG. 4 and an associated graph 130 is illustrated in FIG. 5. In a first step 102 of the method 100, the ignition is engaged and the ICE 12 is started by the driver. A second step 104 of the method 100 includes the PCM 16 receiving data or input from the knock sensor 74. If the PCM 16 receives indication that knocking is occurring from the knock sensor 74, then the third step 106 determines the OR based on the knock activity sensed by the knock sensor 74 and an algorithm. Once the OR is determined to be less than 100% in the fourth step 108, the graph 130 shown in FIG. 5 is consulted to determine if and how much exhaust cam timing should be adjusted. The graph 130 of FIG. 5 depicts the relationship 136 between OR 132 and the recommended degrees of exhaust cam phaser change 134. For example, if there is no evidence of knocking as detected by the knock sensor 74 then the OR is at or near 100% and the exhaust cam phaser will continue operating using the same timing. If there is evidence of knocking as detected by the knock sensor 74 then the PCM performs the algorithm to produce an OR and adjust the exhaust cam timing appropriately. More specifically, if the algorithm finds the OR=50%, the PCM 16 will instruct the exhaust cam phaser 80 to retard the exhaust cam timing by 12.5°. An equation representing the relationship between the OR and the exhaust cam phase change Pd is given as:

Pd=Pf−(OR*Pf),

where Pf is a full phaser shift. The full phaser shift Pf may range from 0 to 90° without departing form the scope of the disclosure.

In the fifth step 110 of the method 100, the PCM determines the recommended exhaust cam phase change and the sixth step 112 of the method communicates the exhaust cam phase change signal to the exhaust cam phaser 80. The method 100 returns the second step 104 at this point to resume knock sensor detection. If in the fourth step 108 the OR is found to be 100%, the method 100 returns the second step 104 at this point to resume knock sensor detection.

Other control parameters can be adjusted by the PCM 16 including modeled airflow, fuel pulse and timing, and spark timing. For example, in some instances, persistent knocking may be alleviated by increasing the amount of fuel that is injected into the cylinder 50 or the intake port 44. Additional fuel has a cooling effect on the air/fuel mixture and may help reduce or eliminate knock. Furthermore, advancing or retarding spark may also help prevent knock depending on the combustion characteristics of a particular combustion chamber design, valve timing, and ambient conditions.

Referring now back to FIG. 1, the PCM 16 is preferably an electronic control device having a preprogrammed digital computer or processor, control logic, memory used to store data, and at least one I/O peripheral. The control logic includes a plurality of logic routines for monitoring, manipulating, and generating data. The PCM 16 controls the plurality of actuators, pumps, valves, and other devices associated with ICE 12 control according to the principles of the present disclosure. The control logic may be implemented in hardware, software, or a combination of hardware and software. For example, control logic may be in the form of program code that is stored on the electronic memory storage and executable by the processor. The PCM 16 receives the output signal of each of several sensors on the vehicle, performs the control logic and sends command signals to several control devices.

For example, a control logic implemented in software program code that is executable by the processor of the transmission controller 26 includes a first control logic for engaging the ignition and starting the ICE 12. A second control logic includes the PCM 16 receiving data or input from the knock sensor 74. If the PCM 16 receives indication that knocking is occurring from the knock sensor 74, then a third control logic determines the OR based on the knock activity sensed by the knock sensor 74 and an algorithm. Once the OR is determined to be less than 100% a fourth control logic, the graph 130 shown in FIG. 5 is consulted to determine if and how much exhaust cam timing should be adjusted. The graph 130 of FIG. 5 depicts the relationship 136 between OR 132 and the recommended degrees of exhaust cam phaser change 134. For example, if there is no evidence of knocking as detected by the knock sensor 74 and the OR is at or near 100%, the exhaust cam phaser will continue operating using the same timing. If there is evidence of knocking as detected by the knock sensor 74 then the PCM performs the algorithm to produce an OR and adjust the exhaust cam timing appropriately. More specifically, if the algorithm finds the OR=50%, the PCM 16 will instruct the exhaust cam phaser 80 to retard the exhaust cam timing by 12.5°.

A fifth control logic determines the recommended exhaust cam phase change and a sixth control logic communicates the exhaust cam phase change signal to the exhaust cam phaser 80. The control logic returns the second control logic at this point to resume knock sensor detection. If in the fourth control logic the OR is found to be 100%, the control logic returns the second control logic at this point to resume knock sensor detection.

While examples have been described in detail, those familiar with the art to which this disclosure relates will recognize various alternative designs and examples for practicing the disclosed method within the scope of the appended claims.

The following is claimed:

1. A method of controlling an internal combustion engine for a vehicle, the method comprising:
providing an internal combustion engine having an exhaust camshaft phaser and a knock sensor;
starting the internal combustion engine;
receiving a first knock sensor signal from the knock sensor;
determining a first octane rating (OR) based on the first knock sensor signal and an algorithm, and
communicating a camshaft timing change to the exhaust camshaft phaser if the first octane rating (OR) is less than 100%.

2. The method of controlling the internal combustion engine of claim 1 further comprising maintaining a current camshaft timing if the first octane rating (OR) is 100%.

3. The method of controlling the internal combustion engine of claim 2 further comprising:
receiving a second knock sensor signal from the knock sensor;
determining a second octane rating (OR) based on the second knock sensor signal and the algorithm, and
communicating a camshaft timing change to the exhaust camshaft phaser if the second octane rating (OR) is less than 100%.

4. The method of controlling the internal combustion engine of claim 2 further comprising:
receiving a second knock sensor signal from the knock sensor;
determining a second octane rating (OR) based on the second knock sensor signal and the algorithm, and
maintaining a current camshaft timing if the second octane rating (OR) is 100%.

5. The method of controlling the internal combustion engine of claim 2 further comprising communicating a camshaft timing change to the exhaust camshaft phaser if the first octane rating (OR) is less than 100% further comprises setting the camshaft timing change (Pd) by the following equation:
Pd=Pf−(OR*Pf); and
wherein Pf is a full phaser shift.

6. The method of controlling the internal combustion engine of claim 5 further comprises setting the full phaser shift is approximately −25°.

7. The method of controlling the internal combustion engine of claim 5 further comprises setting the full phaser shift is approximately −12.5°.

8. The method of controlling the internal combustion engine of claim 1 wherein providing a vehicle having an internal combustion engine having an exhaust camshaft phaser and a knock sensor further comprises providing a vehicle having an internal combustion engine having an exhaust camshaft phaser and a flat-response knock sensor.

9. An internal combustion engine assembly for a vehicle, the internal combustion engine assembly comprising:
a long block assembly comprising a cylinder block, a crankshaft, at least one cylinder bore, at least one piston assembly, and a knock sensor;
a cylinder head assembly comprising an exhaust camshaft and an exhaust camshaft phaser, and wherein the cylinder head assembly is disposed on the long block assembly to form at least one combustion chamber, and
a powertrain control module having a control logic sequence, and wherein the powertrain control module controls the operation of the internal combustion engine assembly.

10. The internal combustion engine assembly of claim 9 wherein the control logic sequence of the powertrain control module comprises:
a first control logic for indicating to the powertrain control module that the internal combustion engine has been started;
a second control logic for receiving a first knock sensor signal from the knock sensor, and
a third control logic for determining an octane rating (OR) based on the knock sensor signal and an algorithm.

11. The internal combustion engine assembly of claim 10 wherein the control logic sequence of the powertrain control module further comprises a fourth control logic for communicating a camshaft timing change to the exhaust camshaft phaser if the octane rating (OR) is less than 100%.

12. The internal combustion engine assembly of claim 11 wherein the control logic sequence of the powertrain control module further comprises a fifth control logic for maintaining a current camshaft timing if the octane rating (OR) is 100%.

13. The internal combustion engine assembly of claim 10 wherein the fourth control logic of the control logic sequence of the powertrain control module comprises setting a camshaft timing change (Pd) by the following equation:
Pd=Pf−(OR*Pf), and
communicating a camshaft timing change to the exhaust camshaft phaser if the octane rating (OR) is less than 100%; and
wherein Pf is a full phaser shift.

14. The internal combustion engine assembly of claim 13 wherein the full phaser shift of the exhaust cam phaser is approximately −25°.

15. The internal combustion engine assembly of claim 13 wherein the full phaser shift of the exhaust cam phaser is approximately −12.5°.

16. The internal combustion engine assembly of claim 13 wherein the knock sensor of the long block assembly is a flat-response knock sensor.

17. A method of controlling an internal combustion engine for a vehicle, the method comprising:
providing an internal combustion engine having an exhaust camshaft phaser and a flat-response knock sensor;
starting the internal combustion engine;
receiving a first knock sensor signal from the knock sensor;
determining a first octane rating (OR) based on the first knock sensor signal and an algorithm;
communicating a camshaft timing change to the exhaust camshaft phaser if the first octane rating (OR) is less than 100%;
maintaining a current camshaft timing if the first octane rating (OR) is 100%;
receiving a second knock sensor signal from the knock sensor;
determining a second octane rating (OR) based on the second knock sensor signal and the algorithm;
communicating a camshaft timing change to the exhaust camshaft phaser if the second octane rating (OR) is less than 100%, and
maintaining a current camshaft timing if the second octane rating (OR) is 100%.

18. The method of controlling the internal combustion engine of claim 17 further comprising communicating a camshaft timing change to the exhaust camshaft phaser if the first octane rating (OR) is less than 100% further comprises setting the camshaft timing change (Pd) by the following equation:
Pd=Pf−(OR*Pf); and
wherein Pf is a full phaser shift.

19. The method of controlling the internal combustion engine of claim 18 further comprises setting the full phaser shift is approximately −25°.

20. The method of controlling the internal combustion engine of claim 18 further comprises setting the full phaser shift is approximately −12.5°.
